(19) United States
(12) Patent Application Publication
(10) Pub. No.: US 2004/0158686 A1
(43) Pub. Date: Aug. 12, 2004

(54) Portable information terminal

(76) Inventor: Hiroyuki Sato, Anjo-shi (JP)

Correspondence Address: POSZ & BETHARDS, PLC, 11250 ROGER BACON DRIVE, SUITE 10, RESTON, VA, 20190, US

(21) Appl. No.: 10/643,915

(22) Filed: Aug. 20, 2003

(30) Foreign Application Priority Data
Sep. 13, 2002 (JP) 2002-268299

(51) Int. Cl. G06F 12/00

(52) U.S. Cl. 711/159; 711/103

(57) ABSTRACT

A portable information terminal is equipped with a flash memory including a data storing region and a directory region for storing programs and data. A memory optimization order is set for instructing execution of optimization processing for the flash memory. The optimization processing includes deletion of data stored in a designated area of the data storing region corresponding to information indicating deletion of the data. Through the optimization processing, the designated area of the data storing region is restored as an available data storing region. The optimization processing for the flash memory is executed in response to stop of electric power supply to the portable information terminal.

### BACKGROUND OF THE INVENTION

This invention relates to a portable information terminal equipped with a flash memory including a data storing region and a directory region for storing programs and data.

A barcode handy terminal (hereinafter, referred to as BHT), known as one of conventional portable information terminals, executes automatic optimization processing for a flash memory when no available memory region remains in the flash memory. In general, this kind of conventional BHT requires approximately 1 second to accomplish the optimization processing for the flash memory. Thus, a user of this BHT is forced to wait for a significant interruption. In other words, this interruption is a dormant or inoperable period of the system.

To eliminate the above-described inconvenience, another conventional BHT is characterized as having the capability of executing the optimization processing for a flash memory only when a user does not touch or manipulate operation keys for a predetermined period of time (e.g., several seconds). However, this conventional BHT cannot predict user's behavior. The user may touch or manipulate the operation keys during execution of the optimization processing. This conventional BHT does not accept any key entry having done by the user during the execution of the optimization processing. In such a case, the user will perceive undesirable time lag in his/her key operation.

As a different approach for solving the above-described inconvenience, another conventional BHT proposes to prepare a specific command instructing the optimization processing for a flash memory. However, the specific command needs to be incorporated into an application program which is installed in the BHT. This will enlarge the burden in preparing or creating the application program.

### SUMMARY OF THE INVENTION

In view of the above-described problems, the present invention has an object to provide a portable information terminal capable of executing the optimization processing for a flash memory without giving unpleasant feeling to a user and also capable of reducing the burden in preparing or creating the application program installed in this system.

In order to accomplish the above and other related objects, the present invention provides a first portable information terminal equipped with a flash memory including a data storing region and a directory region for storing programs and data. The first portable information terminal sets a memory optimization order instructing execution of optimization processing for the flash memory. The optimization processing includes deletion of data stored in a designated area of the data storing region corresponding to information indicating deletion of the data which is recorded in the directory region. Through the optimization processing, the designated area of the data storing region is restored as an available data storing region. Furthermore, the first portable information terminal executes the optimization processing for the flash memory according to the memory optimization order in response to stop of electric power supply to the portable information terminal.

With this arrangement, it becomes possible to execute the optimization processing for the flash memory without giving unpleasant feeling to a user. Furthermore, it becomes possible to reduce the burden in preparing or creating the application program installed in this system.

According to an embodiment of the present invention, it is preferable that the first portable information terminal selectively executes the optimization processing for the flash memory in response to stop of electric power supply to the portable information terminal. And, the first portable information terminal adjusts an optimization size for the flash memory.

Furthermore, the present invention provides a second portable information terminal equipped with a flash memory including a data storing region and a directory region for storing programs and data. The second portable information terminal sets a memory optimization order instructing execution of optimization processing for the flash memory. The optimization processing includes deletion of data stored in a designated area of the data storing region corresponding to information indicating deletion of the data which is recorded in the directory region. Through the optimization processing, the designated area of the data storing region is restored as an available data storing region. And, the second portable information terminal executes the optimization processing for the flash memory according to the memory optimization order in response to execution of a specific statement incorporated in an application program used in the portable information terminal.

The second portable information terminal brings substantially the same functions and effects as those of the above-described first portable information terminal.

According to an embodiment of the present invention, it is preferable that the second portable information terminal selectively determines whether or not the optimization processing for the flash memory should be executed in response to the execution of the specific statement. The second portable information terminal sets the execution timing of the optimization processing for the flash memory to a predetermined point of time earlier or later than the execution of the specific statement. And, the second portable information terminal adjusts an optimization size for the flash memory.

In this case, it is preferable that the specific statement is selected from the group consisting of a statement of receiving a file from a host, a statement of transmitting a file to the host, and a statement of starting communication of the portable information terminal.

Furthermore, the present invention provides a third portable information terminal equipped with a flash memory including a data storing region and a directory region for storing programs and data. The third portable information terminal sets a memory optimization order instructing execution of optimization processing for the flash memory. The optimization processing includes deletion of data stored in a designated area of the data storing region corresponding to information indicating deletion of the data which is recorded in said directory region. Through the optimization processing, the designated area of the data storing region is restored as an available data storing region. And, the third portable information terminal executes the memory optimization order according to the memory optimization order at a designated date/time.

The third portable information terminal brings substantially the same functions and effects as those of the above-described first portable information terminal.

According to an embodiment of the present invention, it is preferable that the third portable information terminal selectively sets the date/time for executing the optimization processing for the flash memory, and adjusts an optimization size for the flash memory.

### BRIEF DESCRIPTION OF THE DRAWINGS

The above and other objects, features and advantages of the present invention will become more apparent from the following detailed description which is to be read in conjunction with the accompanying drawings, in which:

FIG. 1 is a flowchart showing the contents of optimization processing for a flash memory in accordance with a first embodiment of the present invention;

FIG. 2 is a flowchart showing the setting of the optimization processing in accordance with the first embodiment of the present invention;

FIG. 3 is a block diagram showing the arrangement of a barcode handy terminal in accordance with the present invention;

FIG. 4 is a flowchart showing the contents of optimization processing for a flash memory in accordance with a second embodiment of the present invention;

FIG. 5 is a flowchart showing the setting of the optimization processing in accordance with the second embodiment of the present invention;

FIG. 6 is a flowchart showing the contents of optimization processing for a flash memory in accordance with a third embodiment of the present invention; and

FIG. 7 is a flowchart showing the setting of the optimization processing in accordance with the third embodiment of the present invention.

### DESCRIPTION OF THE PREFERRED EMBODIMENTS

Preferred embodiments of the present invention will be explained hereinafter with reference to attached drawings.

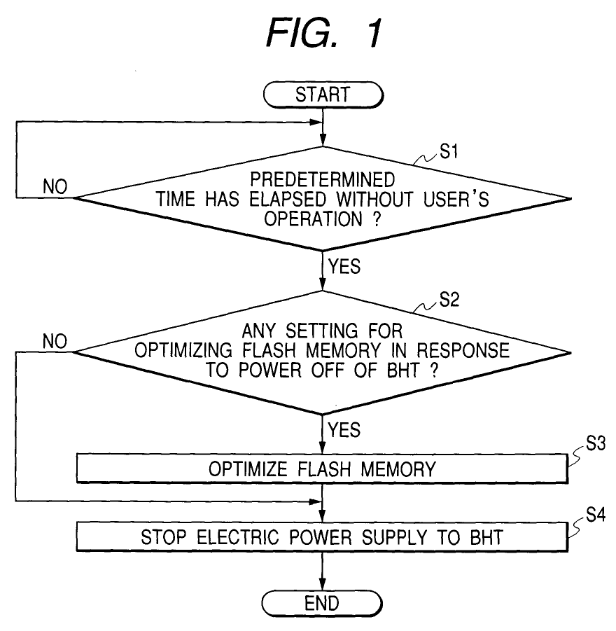

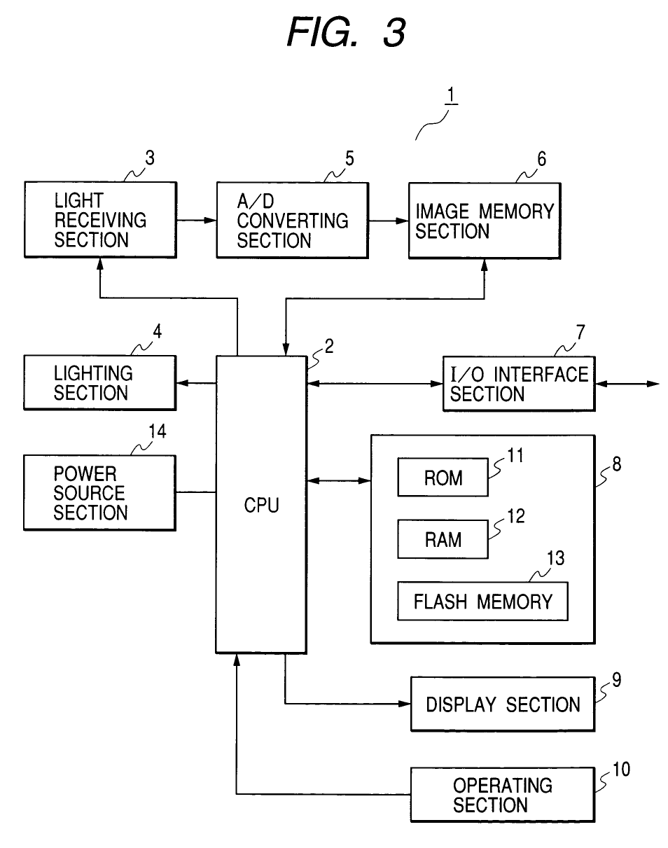

A barcode handy terminal (BHT) in accordance with a first embodiment of the present invention will be explained with reference to FIGS. 1 to 3. FIG. 3 is a schematic diagram showing the BHT (i.e., portable information terminal) 1 of this embodiment as a combination of functional blocks.

As shown in FIG. 3, BHT 1 includes CPU 2 serving as a main component which is connected to a light-receiving section 3 equipped with a light-receiving sensor, a lighting section 4 equipped with an LED, an image memory section 6 receiving a light-receiving signal from the light-receiving section 3 via an A/D converting section 5, an input/output interface section 7 transmitting and receiving data to or from an external device, a memory section 8, a display section 9 equipped with a liquid crystal display, and an operating section 10 equipped with various operation keys.

The memory section 8 includes ROM 11, RAM 12, and a flash memory 13. Furthermore, BHT 1 includes a power source section 14 supplying electric power to CPU 2 or others.

The flowchart of FIG. 1 explains the contents of control of CPU 2 performed for stopping electric power supply to the components of BHT 1. This control processing is one of control functions involved in an operating system (i.e., OS) incorporated in BHT 1. In a step S1, it is checked whether or not a predetermined time has elapsed since a user has released his/her finger from the operation keys of the operating section 10.

When it is judged that the predetermined time has elapsed (i.e., YES in step S1), the control flow proceeds to the next step S2. It is then checked in step S2 whether or not a memory optimization order instructing execution of optimization processing for the flush memory 13 is set so as to be executed in response to stop of electric power supply to the components of BHT 1. When the setting of the optimization processing for the flush memory 13 is present, namely when it is judged that the memory optimization order is set so as to be executed in response to stop of electric power supply to the components of BHT 1 (i.e., YES in step S2), the control flow proceeds to the next step S3. Then, in step S3, the optimization processing for the flash memory 13 is executed according to the memory optimization order. The flash memory 13 includes a data storing region and a directory region for storing programs and data. This optimization processing makes it possible for the flash memory 13 to delete the data stored in a designated area of the data storing region corresponding to information indicating deletion of the data which is recorded in the directory region. Through the optimization processing, the designated area of the data storing region is restored as an available data storing region.

When the judgment result is NO in the above step S2, the control flow skips the step S3.

Then, the control flow proceeds to step S4 to stop electric power supply to BHT 1. This procedure may be generally referred to as “auto power off.”

Furthermore, according to the first embodiment of the present invention, BHT 1 selectively determines whether or not the above-described optimization processing for the flash memory 13 should be executed in response to stop of electric power supply to BHT 1. In other words, BHT 1 has a function of invalidating the memory optimization order so as not to execute the optimization processing for the flash memory 13 when the electric power supply to BHT 1 is stopped.

Furthermore, in the case that the memory optimization order is effectively executed in response to stop of electric power supply to BHT 1, BHT 1 can adjust an optimization size for the flash memory 13. These settings are feasible by allowing a user to manually select or input his/her preference with respect to the contents of the settings thought the operation keys of the operating section 10 with aide of a setting menu screen on the display section 9.

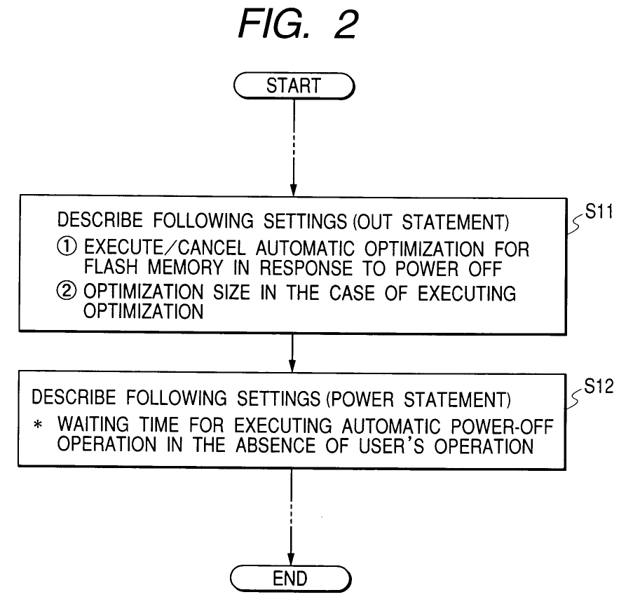

Furthermore, automatic setting for the memory optimization order is feasible by utilizing a statement contained in an application program relating to various settings in BHT 1, which will be explained with reference to the flowchart of FIG. 2.

In step S11, the following settings are described by utilizing an OUT statement.

\mathring{1} Setting with respect to “execution”/“cancellation” of automatic optimization processing for the flash memory 13 in response to stop of electric power supply to BHT 1.

\mathring{2} Setting with respect to the optimization size for the flash memory 13, in the case of “executing” the optimization processing for the flash memory 13.

Then, in step S12, the following setting is described by utilizing a POWER statement.

Setting with respect to a waiting time for executing automatic power-off operation in the absence of user's operation so that the power-off operation is canceled in the event that the user touches any operation key within this waiting time.

As apparent from the foregoing description, the first embodiment of the present invention provides the portable information terminal (BHT 1) which executes the optimization processing for the flash memory in response to stop of electric power supply to the portable information terminal. In other words, the optimization processing for the flash memory is executed without giving adverse influence to user's manipulation for the portable information terminal through the operation keys. Thus, it becomes possible to execute the optimization processing for the flash memory without giving unpleasant feeling to the user. Furthermore, it becomes possible to reduce the burden in preparing or creating the application program installed in this system.

Furthermore, according to the above-described first embodiment of the present invention, the portable information terminal (BHT 1) allows the user to select execution/cancellation of the optimization processing for the flash memory according to his/her preference. Thus, the portable information terminal selectively executes the optimization processing for the flash memory in response to stop of electric power supply to the portable information terminal. Furthermore, when the optimization processing for the flash memory is performed, the portable information terminal (BHT 1) allows the user to adjust the optimization size for the flash memory according to his/her preference.

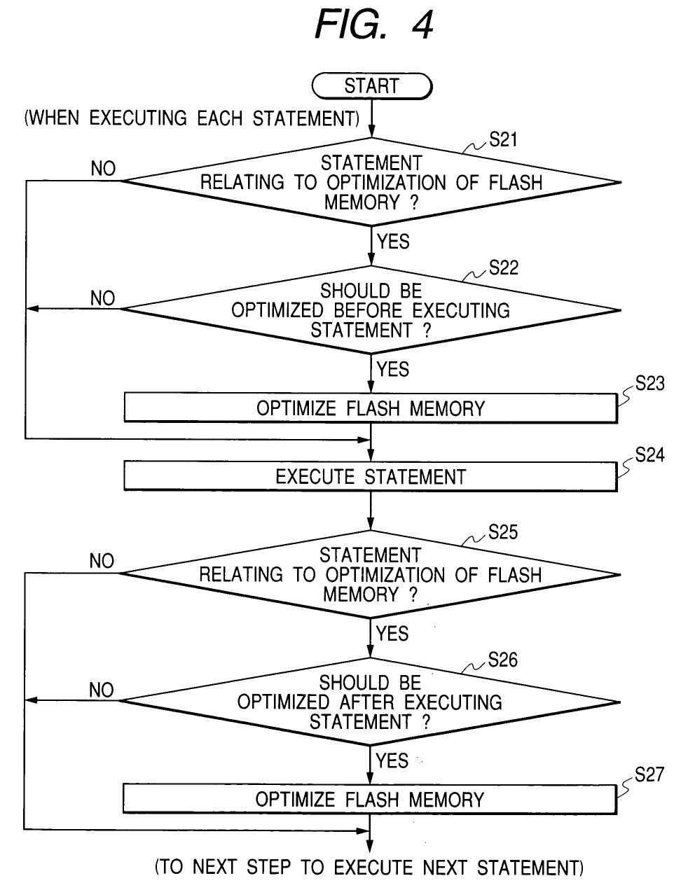

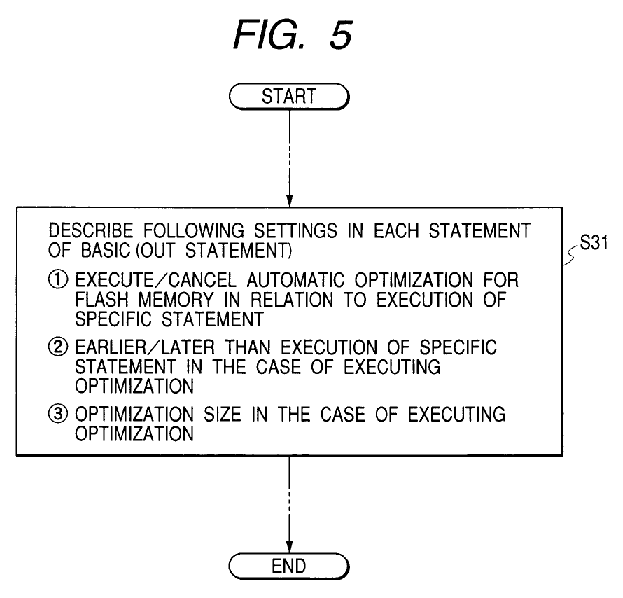

The flowchart of FIGS. 4 and 5 shows the performance of BHT 1 in accordance with a second embodiment of the present invention. The second embodiment is characterized in that the memory optimization order is accompanied with a specific statement of an application program of BHT 1 so that the above-described optimization processing for the flash memory 13 is executed in relation to execution of the specific statement of the application program of BHT 1.

More specifically, as shown in FIG. 4, it is checked in a step S21 whether or not a statement to be executed next in the application program of BHT 1 is a specific statement relating to instruction of the optimization processing for the flash memory 13. When the next statement relates to the instruction of the optimization processing for the flash memory 13 (i.e., YES in step S21), the control flow proceeds the next step S22. In step S22, with reference to the settings involved in this specific statement, it is checked whether or not the optimization processing for the flash memory 13 should be executed before executing this specific statement.

When the judgment result is YES in step S22, the control flow proceeds to the next step S23 to execute the optimization processing for the flash memory 13 according to the memory optimization order. The flash memory 13 includes a data storing region and a directory region for storing programs and data. This optimization processing makes it possible for the flash memory 13 to delete the data stored in a designated area of the data storing region corresponding to information indicating deletion of the data which is recorded in the directory region. Through the optimization processing, the designated area of the data storing region is restored as an available data storing region. After accomplishing the step S23, the control flow proceeds to the next step S24 to execute the specific statement.

Meanwhile, when the judgment result is NO in the steps S21 and S22, the control flow skips the step S23 and directly proceeds to the step S24 to execute the specific statement.

After accomplishing the step S24, the control flow proceeds to the next step S25 to further check whether or not the statement having been executed immediately before in the application program of BHT 1 is the specific statement relating to instructing execution of the optimization processing for the flash memory 13. When the statement having been executed immediately before relates to the instruction of the optimization processing for the flash memory 13 (i.e., YES in step S25), the control flow proceeds the next step S26. In step S26, with reference to the settings involved in this specific statement, it is checked whether or not the optimization processing for the flash memory 13 should be executed after executing this specific statement.

When the judgment result is YES in step S26, the control flow proceeds to the next step S27 to execute the optimization processing for the flash memory 13 according to the memory optimization order. The processing in the step S27 is identical with the above-described processing in the step S23. After accomplishing the step S27, the control flow proceeds to the next step to execute the next statement.

Meanwhile, when the judgment result is NO in the steps S25 and S26, the control flow skips the step S27.

Furthermore, according to the second embodiment, BHT 1 selectively determines whether or not the above-described optimization processing for the flash memory 13 should be executed in relation to the specific statement in the application program of BHT 1. In other words, BHT 1 has a function of invalidating the memory optimization order so as not to execute the optimization processing for the flash memory 13 in relation to the specific statement in the application program of BHT 1.

Furthermore, in the case that the memory optimization order is effectively set in relation to the specific statement, BHT 1 can further determine the timing of the optimization processing for the flash memory 13. Namely, BHT 1 can flexibly set the timing of the optimization processing to a predetermined point of time earlier or later than the execution of the specific statement.

Furthermore, BHT 1 can adjust an optimization size for the flash memory 13. These settings are feasible by allowing a user to manually select or input his/her preference with respect to the contents of the settings thought the operation keys of the operating section 10 with aide of a setting menu screen on the display section 9.

Furthermore, automatic setting for the memory optimization order is feasible by utilizing a statement contained in an application program relating to various settings in BHT 1, which will be explained with reference to the flowchart of FIG. 5.

In step S31, the following settings are described by utilizing an OUT statement (e.g., BASIC).

\mathring{1} Setting with respect to “execution”/“cancellation” of automatic optimization processing for the flash memory 13 in relation to execution of the specific statement of BHT 1.

\mathring{2} Setting with respect to the timing of the optimization processing to be executed “earlier”/“later” than the execution of the specific statement, in the case of “executing” the optimization processing for the flash memory 13.

\mathring{3} Setting with respect to the optimization size for the flash memory 13, in the case of “executing” the optimization processing for the flash memory 13.

The rest of the second embodiment is identical with that of the first embodiment. Thus, the second embodiment brings substantially the same functions and effects as those of the first embodiment.

For example, it is preferable that the specific statement used in the second embodiment is a statement of receiving a file (e.g., a master file) from a host (e.g., an external computer connected to BHT 1 for data communication). In general, it will take a relatively long time (several minutes) for accomplishing the process of receiving the master file. Compared with the time required for accomplishing the process of receiving the master file, the time required for accomplishing the optimization processing for the flash memory 13 is negligible. Accordingly, executing the optimization processing for the flash memory 13 is not unpleasant interruption for the user, in this case.

Alternatively, the specific statement used in the second embodiment is a statement of transmitting a file to the host or a statement of starting communication of BHT 1. In any case, substantially the same functions and effects will be obtained. If the optimization processing for the flash memory 13 is executed during the communication, communication data will be lost due to inhibition of interrupt. Hence, it is necessary to prevent the optimization processing from being executed during the communication.

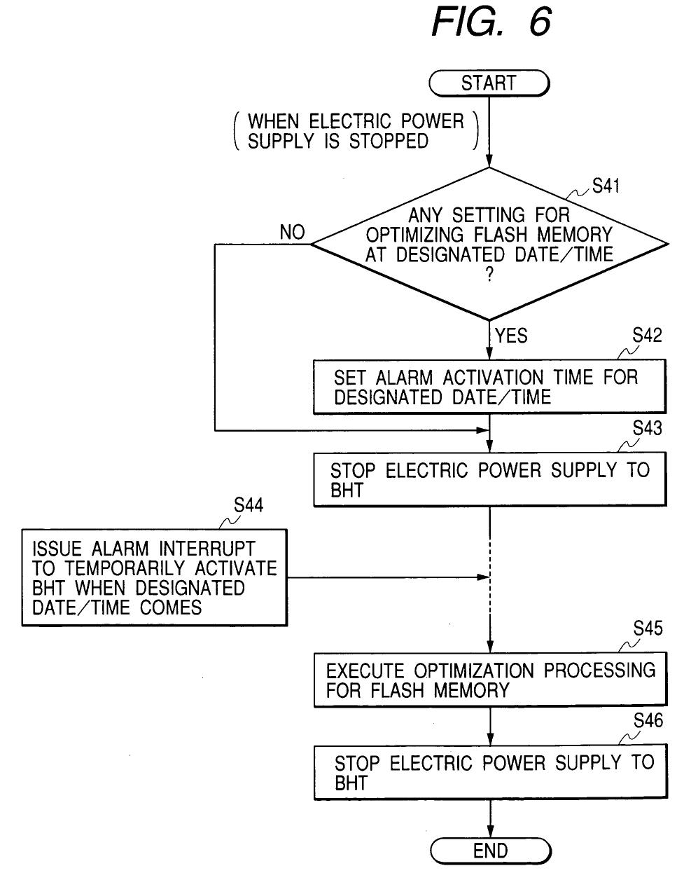

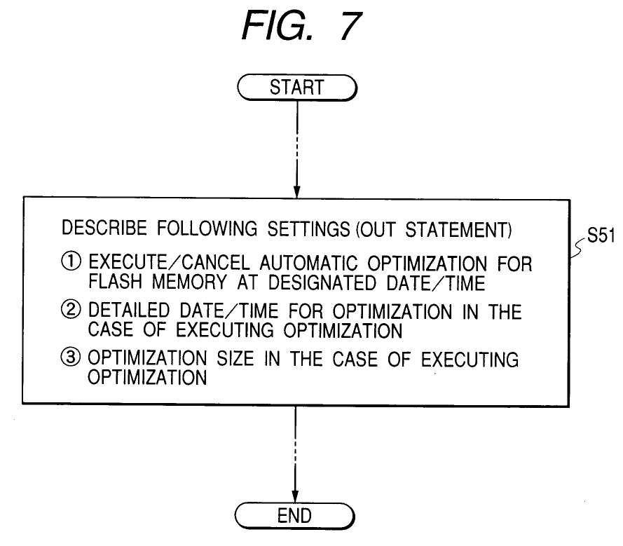

The flowchart of FIGS. 6 and 7 shows the performance of BHT 1 in accordance with a third embodiment of the present invention. The third embodiment is characterized in that the above-described memory optimization order for optimizing the flash memory 13 is executed at a designated date/time. Preferably, the designated date/time for the memory optimization order is a night time or an appropriate point of a dormant period of BHT 1. According to this embodiment, the optimization processing for the flash memory 13 is automatically executed when the designated date/time (e.g., 12PM) comes. In this case, if no electric power is supplied to BHT 1 at this moment, it is preferable to issue an alarm interrupt to temporarily activate BHT 1 and execute the optimization processing for the flash memory 13.

More specifically, as shown in the flowchart of FIG. 6, when electric power supply to BHT 1 is stopped, e.g., at the moment of “auto power off” or in response to user's manipulation for the power off, the control flow proceeds to step S41. In step S41, it is checked whether or not there is any setting for executing the optimization processing for the flash memory 13 at a designated date/time. In other words, it is checked if the memory optimization order is present. When the setting for such optimization processing is present (YES in step S41), the control flow proceeds to the next step S42. In step S42, an alarm activation time is set to the above-described designated date/time. Then, in step S43, electric power supply to BHT 1 is stopped. When the judgment result is NO in the step S41, the control flow skips the step S42 and directly proceeds to the step S43.

Subsequently, when the designated date/time comes, an alarm interrupt is issued to temporarily activate BHT 1 (step S44). Then, the control flow proceeds to the next step S45 to execute the optimization processing for the flash memory 13 according to the memory optimization order. The flash memory 13 includes a data storing region and a directory region for storing programs and data. This optimization processing makes it possible for the flash memory 13 to delete the data stored in a designated area of the data storing region corresponding to information indicating deletion of the data which is recorded in the directory region. With the optimization processing, the designated area of the data storing region is restored as an available data storing region. After accomplishing the step S45, the control flow proceeds to the next step S46 to stop electric power supply to BHT 1.

Furthermore, according to the third embodiment, BHT 1 selectively determines whether or not the above-described optimization processing for the flash memory 13 should be executed at the designate date/time. In other words, BHT 1 has a function of invalidating the memory optimization order so as not to execute the optimization processing for the flash memory 13 at the above-described date/time.

Furthermore, in the case that the memory optimization order is effectively set at the designated date/time, BHT 1 can further determine the timing of the optimization processing for the flash memory 13. Namely, BHT 1 can flexibly set the timing of the optimization processing to an appropriate time.

Furthermore, BHT 1 can adjust an optimization size for the flash memory 13. These settings are feasible by allowing a user to manually select or input his/her preference with respect to the contents of the settings thought the operation keys of the operating section 10 with aide of a setting menu screen on the display section 9.

Furthermore, automatic setting for the memory optimization order is feasible by utilizing a statement contained in an application program relating to various settings in BHT 1, which will be explained with reference to the flowchart of FIG. 7.

In step S51, the following settings are described by utilizing an OUT statement.

\mathring{1} Setting with respect to “execution”/“cancellation” of automatic optimization processing for the flash memory 13 at a designated date/time.

\mathring{2} Setting with respect to details of the date/time (e.g., date, hour, minute, and second; e.g., once a day at 00:00, or at 12PM of Sunday night) of the optimization processing, in the case of “executing” the optimization processing for the flash memory 13.

\mathring{3} Setting with respect to the optimization size for the flash memory 13, in the case of “executing” the optimization processing for the flash memory 13.

The rest of the third embodiment is identical with that of the first embodiment. Thus, the third embodiment brings substantially the same functions and effects as those of the first embodiment.

If BHT 1 is operating at the designated date/time, it will be preferable to cancel the optimization processing for the flash memory 13.

The present invention is not limited to BHT 1 and accordingly can be applied to many of other types of portable information terminals.

What is claimed is:

1. A portable information terminal equipped with a flash memory including a data storing region and a directory region for storing programs and data, comprising:
means for setting a memory optimization order instructing execution of optimization processing for the flash memory, said optimization processing including deletion of data stored in a designated area of said data storing region corresponding to information indicating deletion of the data which is recorded in said directory region, for restoring said designated area of said data storing region as an available data storing region, and
means for executing said optimization processing for the flash memory according to said memory optimization order in response to stop of electric power supply to said portable information terminal.

2. The portable information terminal in accordance with claim 1, wherein said further comprising
means for selectively determining whether or not said optimization processing for the flash memory should be executed in response to the stop of electric power supply to said portable information terminal, and
means for adjusting an optimization size for the flash memory.

3. A portable information terminal equipped with a flash memory including a data storing region and a directory region for storing programs and data, comprising:
means for setting a memory optimization order instructing execution of optimization processing for the flash memory, said optimization processing including deletion of data stored in a designated area of said data storing region corresponding to information indicating deletion of the data which is recorded in said directory region, for restoring said designated area of said data storing region as an available data storing region, and
means for executing said optimization processing for the flash memory according to said memory optimization order in response to execution of a specific statement incorporated in an application program used in said portable information terminal.

4. The portable information terminal in accordance with claim 3, further comprising
means for selectively determining whether or not said optimization processing for the flash memory should be executed in response to the execution of said specific statement,
means for setting execution timing of said optimization processing for the flash memory to a predetermined point of time earlier or later than the execution of said specific statement, and
means for adjusting an optimization size for the flash memory.

5. The portable information terminal in accordance with claim 3, wherein said specific statement is selected from the group consisting of a statement of receiving a file from a host, a statement of transmitting a file to said host, and a statement of starting communication of said portable information terminal.

6. A portable information terminal equipped with a flash memory including a data storing region and a directory region for storing programs and data, comprising:
means for setting a memory optimization order instructing execution of optimization processing for the flash memory, said optimization processing including deletion of data stored in a designated area of said data storing region corresponding to information indicating deletion of the data which is recorded in said directory region, for restoring said designated area of said data storing region as an available data storing region, and
means for executing said optimization processing for the flash memory according to said memory optimization order at a designated date/time.

7. The portable information terminal in accordance with claim 6, further comprising
means for selectively setting said date/time for executing said optimization processing for the flash memory, and
means for adjusting an optimization size for the flash memory.
